(19) United States
(12) Patent Application Publication
(10) Pub. No.: US 2021/0204193 A1
(43) Pub. Date: Jul. 1, 2021

(54) ACCESS BARRING CONTROL

(71) Applicant: Telefonaktiebolaget LM Ericsson (publ), Stockholm (SE)

(72) Inventors: Jarl Tomas HOLMSTROM, Dalby (SE); Hans Krister Mikael SALLBERG, Lund (SE)

(21) Appl. No.: 16/079,314

(22) PCT Filed: Jun. 20, 2018
(86) PCT No.: PCT/EP2018/066406

§ 371 Date: Aug. 23, 2018

Related U.S. Application Data
(60) Provisional application No. 62/546,792, filed on Aug. 17, 2017.

(51) Int. Cl. H04W 48/06; H04W 48/12; H04L 29/06

(52) U.S. Cl. CPC H04W 48/06; H04L 69/16; H04W 48/12

(57) ABSTRACT

The present disclosure relates generally to access control more specifically to methods for uplink data packet barring control in a wireless device, corresponding computer program products and wireless devices. The present disclosure provides solutions which seek to mitigate, alleviate, or eliminate one or more of the above-identified deficiencies in the art and to provide solutions for barring data traffic of a wireless device.

### TECHNICAL FIELD

The present disclosure relates generally to access control more specifically to methods for uplink data packet barring control in a wireless device, corresponding computer program products and wireless devices.

### BACKGROUND

Universal Mobile Telecommunication System (UMTS), Long Term Evolution (LTE), and 5G, are examples of technologies for realizing high-speed packet-based communication in wireless communication systems. Under some circumstances, there may be a need to protect such wireless communication systems in various overload situations by barring a wireless device, e.g., a user equipment (UE) or a machine device (MD), from making access attempts or to respond to pages in a specified area of communications network. Radio access barring control refers to a traffic congestion control technology for securing and ensuring the success of more critical communications by restricting connectivity for mobile terminals to base stations. Such situations may arise during states of emergency or when co-located communications networks (such as core network) are failing.

Access control may be enabled by broadcasting of messages on a cell by cell basis indicating a class or category of subscriber barred from network access. In current standards, all UEs are members of one out of ten randomly allocated mobile populations, defined as Access Classes (AC) 0 to 9. The population number is stored in the SIM/USIM. In addition, UEs may be members of one or more out of 5 special Access Classes 11 to 15, also held in the SIM/USIM. In case of an overload situation like emergency or congestion, the network may want to reduce the access overload in the cell. To reduce the access from the UE, the network may signal barred classes over the air interface, e.g., in a broadcast message. If the UE is a member of at least one access class which corresponds to the 5 special access classes, and the access class is applicable in the serving network, access attempts are allowed.

In the standardization of UMTS and LTE a plurality of access control mechanisms are specified to prevent access attempts of the wireless device, e.g., Access Class Barring (ACB), Extended Access Barring (EAB), Service Specific Access Control (SSAC), and Application Specific Congestion Control for Data Communication (ACDC). In 5G, a unified access control providing the combined functionality of some earlier barring mechanisms is considered. Such a unified access control should be flexible and provide support for multiple accesses, e.g., NR and LTE, support for future requirements, i.e., forward compatibility as well as support for barring also in connected mode. In connected mode the bearer services for e.g. IP flows has been established through control plane logic and signaling and the UE is sending and receiving data packets in the user plane.

Present proposals for unified access control mechanism are primarily handling barring of control plane service attempts which follows an access stratum (AS) and Non access stratum (NAS) separation with a service-agnostic AS part making barring decision/enforcement for each access category and a “service”-related NAS part determining for each access attempt which category it belongs to. The wireless device NAS determines for each uplink access attempt the access category to apply based on given access category rules. The network AS may broadcast barring information for each access category as part of system information. The wireless device uses this barring information to reach a barring decision for the applicable access category. Thus, common for the proposed methods is that the barring enforcement is proposed to be carried out in an access stratum.

Common for all methods described and proposed in [C1-172279] [C1-172601] [C1-172278], including discussed methods for connected mode barring in [C1-172279] [C1-172278], is that the barring enforcement is proposed to be carried out in the access stratum (Radio Resource Control, RRC). Barring enforcement in the access stratum for connected mode barring where barring of user plane data packets is needed is non-optimal.

The 5G System supports multiple accesses, e.g. NR and LTE, connected to the same Core Network. In order to achieve the same barring enforcement for all 5G accesses, each access would have to implement and apply the same barring mechanism.

In addition, the method for “Connected mode ACDC” relies on that a data packet is associated with an (Application ID, OS ID) pair. Such parameters are often manufacturer dependent and applicable only to “well-known” applications. This make it very difficult to provide a regulated wireless device product behavior compliant to an international standard that can be tested and verified for compliance.

Consequently, there is a need to improve barring enforcement for connected mode wireless devices.

### SUMMARY

An object of the present disclosure is to provide solutions which seek to mitigate, alleviate, or eliminate one or more of the above-identified deficiencies in the art and to provide solutions for barring data traffic of a wireless device.

According to a first aspect of the disclosure, this object is achieved by a method for uplink data packet barring control in a wireless device. The method comprises receiving a data packet from an application in the wireless device and determining access category for the data packet. The method further comprises controlling user plane, UP, barring of the data packet based on the determined access category.

In some embodiments, controlling UP barring of data packets comprises discarding one or more data packets when the applied access category marking matches a barred access category.

In some embodiments, determining access category comprises performing uplink filtering of data packets to determine an access category; and applying an access category marking representing the determined access category.

In some embodiments, performing uplink filtering of data packet comprises filtering of data packets on IP/UDP/TCP protocol parameters.

In some embodiments, access category is determined from access category rules applicable to respective applications.

In some embodiments, the access category rules comprise packet filter information regarding one or more packet filter(s) to use to map packet flows to an access category.

In some embodiments, uplink filtering of data packets to determine an access category is performed in a filter applicable for Quality of Service (QoS) flow separation.

In some embodiments, uplink filtering for determining access category are received in a NAS signalling message from the communications network.

In some embodiments, the method is performed for a wireless device in a state where there is an active packet data flow from an application.

In some embodiments, the data packets are part of an ongoing data packet stream from an application.

In some embodiments, the method is performed for an RRC idle, RRC inactive and RRC connected mode wireless device.

In some embodiments, the wireless device obtains barring information from one or more downlink broadcast messages received from an access node.

In some embodiments, the wireless device returns barring information to the application from which the one or more data packets are received.

According to a second aspect, the object of the present disclosure is achieved by a computer readable storage medium, having stored thereon a computer program which, when executed in a wireless device, causes execution of the method according to the first aspect.

According to a third aspect of the disclosure, the object of the present disclosure is also obtained by a wireless device arranged for uplink data packet barring control, the wireless device comprising processing circuitry configured to receive a data packet from an application in the wireless device and to determine access category for the data packet. The processing circuitry is further configured to control user plane, UP, barring of the data packet based on the determined access category.

In summary, the present disclosure proposes barring enforcement to be performed in the protocol layers above the access stratum. The same mechanism is used irrespective of the 5G access currently in use, e.g., New Radio (NR), LTE, in the access stratum.

For any or all of first to third aspects mentioned above, it is additionally proposed to use data packet filtering on IP/UDP/TCP protocol parameters to determine access category. The analysis to determine access category could further be optimized by re-use of the logic needed for uplink filtering of data packets in the wireless device to determine to which uplink QoS flow a packet belongs. When using the same logic, the only additional part needed is the ability to map to an access category (in addition to a QoS flow ID) and when applicable determine that a packet should be discarded and not forwarded to the access stratum.

The aspects provide the advantage that data packet filtering on IP/UDP/TCP protocol parameters to determine access category, allows for further possibilities of data packet classification that would not be manufacturer dependent.

The solutions presented in the present disclosure are applicable for all wireless device states and may have well defined none OS dependent applications such as SMS, VoLTE voice and/or video as specific barring categories. When e.g. a new VoLTE call is set-up a user plane IP Flow with specific packet filtering is established and linked to the barring category e.g. realized as a table with linked uplink packet filters.

### BRIEF DESCRIPTION OF DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 illustrates the principle for classification and User Plane marking for QoS Flows and mapping to access node, AN, Resources

FIG. 2 illustrates a network node communication scenario with a plurality of barred wireless devices;

FIG. 3
a. is a flowchart illustrating exemplary method steps performed in a wireless device;
b. is a flowchart illustrating exemplary method steps performed in a wireless device;

FIG. 4
a. illustrates an example wireless device configuration;
b. illustrates an example wireless device configuration; and
c. illustrates an example wireless device configuration.

### DETAILED DESCRIPTION

Aspects of the present disclosure will be described more fully hereinafter with reference to the accompanying drawings. The methods and arrangements disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. As used herein, the singular forms “a”, “an” and “the” are intended to include the plural forms as well, unless the context clearly indicates otherwise.

In the following disclosure, the term wireless device will be used to refer to remote wireless equipment that are configured for wireless access to a network node, e.g., a mobile device (MD), mobile station (MS), user equipment (UE), subscriber station, remote terminal, wireless terminal, user device (such as a mobile telephone or smartphone) or a stationary device or semi-stationary device, e.g., a sensor data reporting device set up for Machine Type Communication, MTC, in a wireless network structure. A network infrastructure component that provides wireless access to a wireless device will be referred to as an access node. Depending on the network type, other well-known terms for such a network entity are base station (BS), eNodeB, eNB or access point. These terms may be used interchangeably and are used to refer to network infrastructure components that provide wireless access to wireless devices.

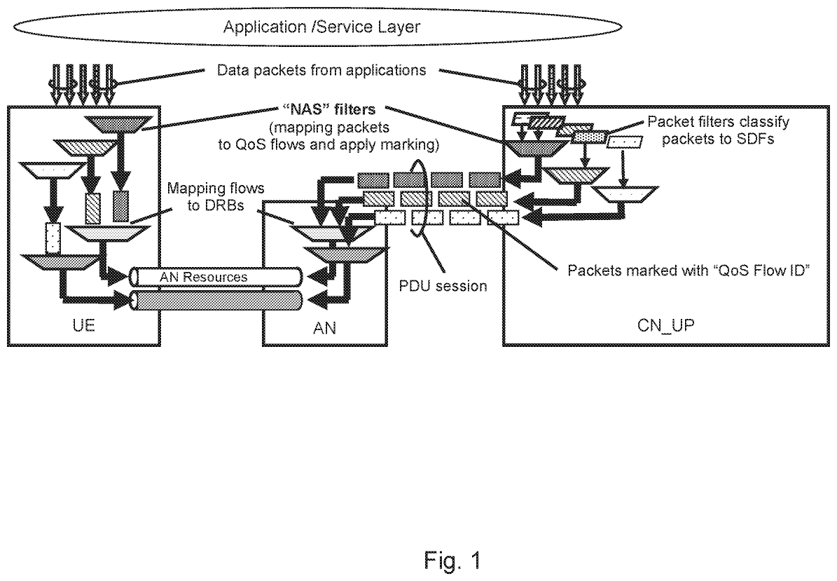

FIG. 1 illustrates the principle for classification and User Plane marking for QoS Flows and mapping to access node (AN) resources. The packet filters used for uplink filtering of data packets in the wireless device (and downlink filtering in the core network upser plane (CN_UP) are denoted “NAS” filters.

The present disclosure proposes barring enforcement for connected mode barring in the layers above the access stratum in the wireless device. The solution may also be extended to performing barring enforcement for all other states of the wireless device at the layers above the access stratum. One of the issues with some of the legacy barring methods is that they are only applicable in idle mode, mostly due to implementation complexity.

For connected mode, evaluation of uplink data packets in order to assess to which access category they belong (access category determination) is performed using data packet filtering on IP/UDP/TCP protocol parameters. Data packets are mapped to an access category according to the Access Category Rules, that include information about packet filter(s) related to applications belonging to the different access categories. The data packets could be part of already ongoing packet streams from applications or the initial packet of a newly initiated packet stream. If a packet belongs to an access category that is currently barred according to the barring information broadcasted from the network to the wireless device, it is discarded and hence not forwarded to the access stratum. Complementary information about the barring could be sent to upper layers, e.g. to the application(s) sending the barred data packets, or to the Man-Machine Interface to inform the user of the barring condition.

In the present disclosure, it is proposed to perform access category determination as well as barring enforcement for connected mode barring re-using the logic presented in FIG. 1, or alternatively the same type of logic. The present logic, disclosed as NAS filters in FIG. 1, is defined for uplink filtering of data packets in the wireless device to determine to which uplink QoS flow a packet belongs. This logic is defined to be placed in the layer above the access stratum in the wireless device. In the present disclosure, re-use of these uplink filters for data packet filtering on IP/UDP/TCP protocol parameters is proposed to determine the access category for each data packet. As an alternative separate uplink packet filters could be utilized.

The additional logic needed for the present disclosure, is the ability to map packet flows to an access category and apply access category marking (in addition to “mapping packets to QoS flows and apply marking”). Additionally, after marking with access category, logic to determine if a packet should be discarded instead of being forwarded to the access stratum.

Notifications about discarded traffic could be sent to upper layers, e.g. to the application(s) responsible for the affected data packet flow. This may trigger the application to throttle and buffer data within the application or perform actions within the application to make the user of the application reduce generation of new data to be sent uplink to the network if applicable or turn the IP flow off during the barring condition. Notifications could also be sent directly to the Man-Machine Interface to inform the wireless device user.

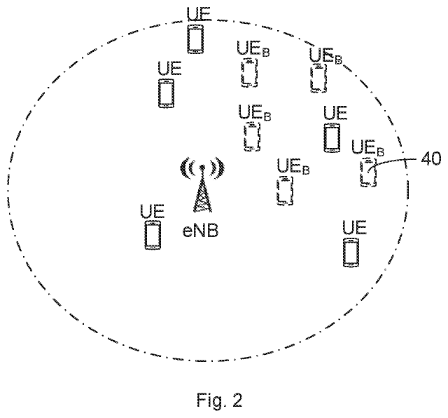

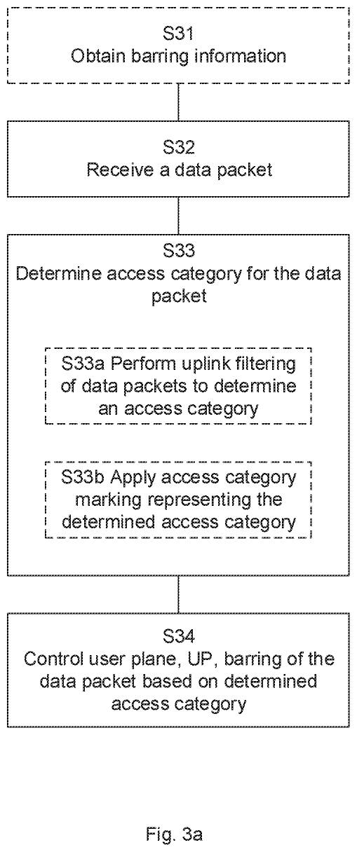

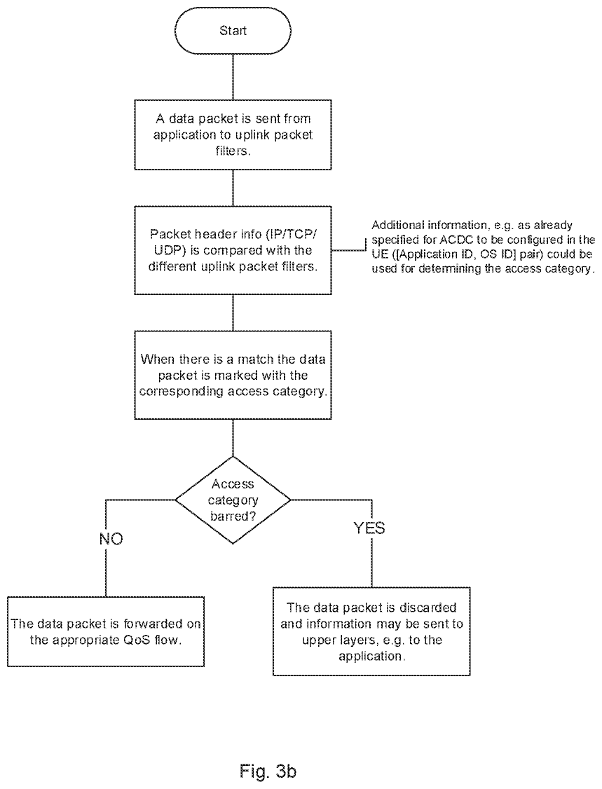

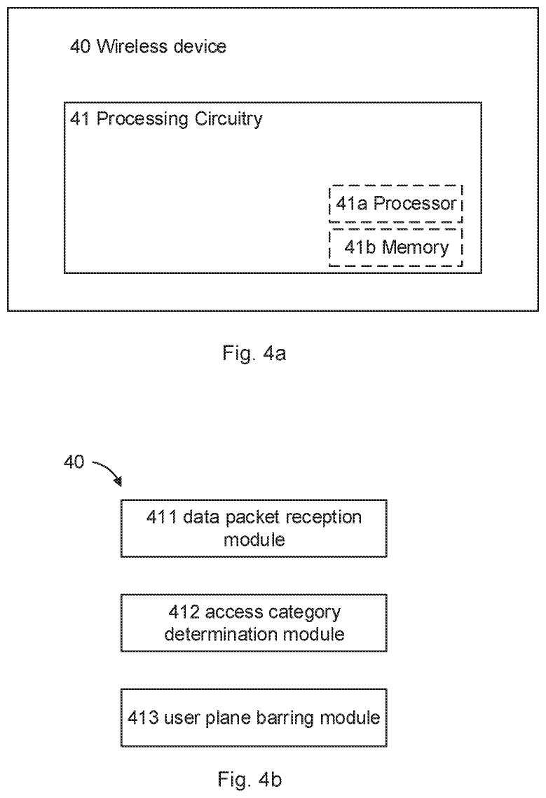

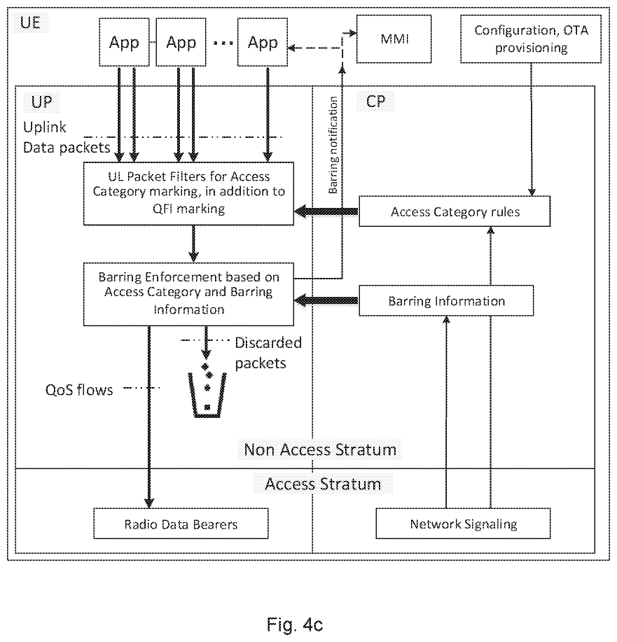

FIG. 2 illustrates a network node communication scenario with a plurality of wireless devices 40 that are either subject to barring due to e.g., a congestion situation or maintain the ability to request access to the network. In the disclosure, barred wireless devices are indicated as UEs while wireless devices that are not associated with a barred access category are indicated as UE. The method embodiments and wireless device configurations presented here below are applicable in the disclosed scenario as well as in many other scenarios operating where barring information may be used. According to existing technologies, the barring information, governing barring decisions, is broadcasted to wireless devices from the radio network, i.e., from the access node. Access Category Rules, used to determine access categories, is provisioned in the wireless device using network signaling or over the air (OTA) provisioning. For the proposed invention, the Access Category Rules applicable to applications utilizing User Plane data bearers, are amended with the packet filter(s) to use to map packet flows to an access category and apply access category marking.

In its core essence, the present disclosure provides for barring enforcement for connected mode barring to be carried out in the layer above the access stratum. Also the barring enforcement for all other states of the wireless device may be performed at the layers above the access stratum.

Existing uplink packet filters currently defined for data packet filtering on IP/UDP/TCP protocol parameters may be reused in the determination of access category. Alternatively separate uplink packet filters may be used to determine access category.

Access Category Rules applicable to applications utilizing User Plane data bearers, may be amended to specify the packet filter(s) to use when mapping packet flows to an access category and applying the access category marking. The information on packet filters is added/removed when the related User Plane Data bearers are activated/deleted.

According to the present disclosure, logic is added to map packet flows to an access category and apply access category marking. Also, logic is added to determine if a packet should be discarded instead of being forwarded to the access stratum. Information about discarded traffic could be sent to upper layers, e.g. to the application(s) responsible for the affected data packet flow.

FIG. 3a is a flowchart illustrating exemplary method steps performed in a wireless device. In an optional, initial step S31, the wireless device obtains barring information, e.g., by receiving one or more downlink broadcast messages from an access node and retrieving barring information.

In its most general form, the method for uplink data packet barring control in a wireless device is initiated with the step S32 of receiving a data packet from an application in the wireless device. According to some embodiments, the method is performed for a wireless device in a state where there is an active packet data flow from an application or when the data packet is part of an ongoing data packet stream from an application.

Access category for the data packet is determined in step S33 and in step S34 user plane, UP, barring of the data packet is controlled based on the determined access category. Thus, barring enforcement for connected mode barring is carried out in the layer above the access stratum. This general solution wherein barring enforcement is performed in a layer above the access stratum is of course also applicable to barring enforcement for other states of the wireless device, e.g., for an RRC idle, RRC inactive and RRC connected mode wireless device.

According to some embodiments, controlling UP barring of data packets comprises discarding one or more data packets when the applied access category marking matches a barred access category. Consequently, logic may be added to determine if a packet should be discarded instead of being forwarded to the access stratum. Information about discarded traffic could be sent to upper layers, e.g. to the application(s) responsible for the affected data packet flow.

According to some embodiments, determining access category comprises performing S33a uplink filtering of data packets to determine an access category; and applying S33b an access category marking representing the determined access category. Logic may be added to map packet flows to an access category and to apply the access category marking.

According to some embodiments, performing uplink filtering of data packet comprises filtering of data packets on IP/UDP/TCP protocol parameters. Existing uplink packet filters currently defined for data packet filtering on IP/UDP/TCP protocol parameters may be re-used to determine access category; alternatively separate uplink packet filters may be used to determine access category.

According to some embodiments, access category is determined from access category rules applicable to respective applications. In some embodiments, the access category rules comprise packet filter information regarding one or more packet filter(s) to use to map packet flows to an access category. Access Category Rules applicable to applications utilizing User Plane data bearers, may be amended with the packet filter(s) as exemplified in Table 1 below. The packet filter(s) are used to map packet flows to an access category and apply access category marking. The information on packet filters is added/removed when the related User Plane Data bearers are activated/deleted.

TABLE 1

| Access | | | |
|---|---|---|---|
| Category | Barred | Rule Criteria | Uplink Packet Filters |
| 1 | No | Emergency | N/A |
| | | Signalling | |
| 2 | No | NAS Signaling | N/A |
| 3 | No | SMS | N/A |
| 3 | No | MMTel Voice | Packet Filter A, |
| | | | Packet Filter B |
| 4 | Yes | MMTel Video | Packet Filter C |
| 5 | No | Category A APPs | Packet Filter D, |
| | | | Packet Filter E |
| 6 | Yes | Category B APPs | Packet Filter F |
| . . . | . . . | . . . | . . . |

Access Category rules, amended with information on Uplink Packet Filters as described above, are provisioned to the wireless device, e.g., via network signaling, OTA provisioning or other means. According to some embodiments, uplink filters for determining access category are received in a NAS signaling message from the communications network. The wireless device control plane (CP) may host barring Information broadcasted via RRC signaling to the wireless device from the radio network, i.e., from one or more access nodes. The Access Category Rules and the barring information for wireless device originated uplink signaling and data may be organized as a joint table e.g. as depicted in Table 1.

The information on Uplink Packet Filters is added to the table when an application's request for a data bearer resource results in the setup of such bearer resources and a related Uplink Packet Filter is signaled to the wireless device. When a data bearer resource is inactivated the corresponding Uplink Packet Filters are removed from the table.

According to some embodiments, uplink filtering of data packets to determine an access category is performed in a filter applicable for QoS flow separation. In the UP, during forwarding of uplink data packets, the Uplink Packet Filters are used for Access Category (AC) marking, based on the Access Category rules from CP. The packet filter mechanism could be the same as is used for QoS Flow Identity (QFI) marking, needed for QoS flow separation. After AC- and QFI marking, the data packets are forwarded to the Barring Enforcement entity that performs barring enforcement based on the Barring Information from CP. Barred packets are discarded (or alternatively buffered for some time period) while non-barred are forwarded to the access stratum. According to some embodiments, the wireless device returns barring information to the application from which the one or more data packets are received. Thus, the barring Enforcement entity may send barring notifications to upper layers, e.g. to applications or to the Man-Machine Interface (MMI).

Turning to FIG. 3b, example method steps performed for uplink data packet barring control are disclosed. The flowchart illustrates how a packet is sent from an application, compared with uplink packet filters to determine the access category, and then checked to see if the determined access category is barred. If the access category is barred then the packet is discarded and an indication could be sent to upper layers, otherwise the packet is forwarded on the appropriate QoS flow. The appropriate QoS flow has previously been determined using known techniques also utilizing the uplink packet filters.

A data packet is sent from an application in the wireless device to an uplink packet filter. Evaluation of the data packet in order to assess to which access category the packet belongs (access category determination) is performed using data packet filtering on IP/UDP/TCP protocol parameters, e.g., by comparing packet header info with the different uplink packet filters. Additional information, e.g., as already specified for Application-specific congestion control for data communication (ACDC) to be configured in the wireless device [application ID, OS ID] pair, could be used for determining the access category. When there is a match with an access category, an access category marking is assigned to the data packet, i.e., the data packet is marked with the corresponding access category. Data packets are mapped to an access category according to the Access Category Rules that include information about packet filter(s) related to applications belonging to the different access categories. The data packets could be part of already ongoing packet streams from applications or the initial packet of a newly initiated packet stream. If a packet belongs to an access category that is currently barred according to the barring information broadcasted from the network to the wireless device, it is discarded and hence not forwarded to the access stratum. Complementary information about the barring could be sent to upper layers, e.g. to the application(s) sending the barred data packets, or to the Man-Machine Interface to inform the user of the barring condition. When a packet belongs to an access category that is not barred, the data packet is forwarded on the appropriate QoS flow.

It should be appreciated that FIGS. 3a and 3b comprises some operations which are illustrated with a darker border and some operations which are illustrated with a dashed border. The operations which are comprised in a darker border are operations which are comprised in the broadest, generic example embodiment. The operations which are comprised in a dashed border are example embodiments and represent optional operations that may be added to the broadest, generic example embodiment. In some implementations and according to some aspects of the disclosure, functions disclosed as performed in a certain order in a block of the block diagram can occur out of the order, accordingly, it should be appreciated that the operations do not need to be performed in order. Furthermore, it should be appreciated that optional operations are truly optional, and as such do not need to be performed, nor be performed at all, in order to arrive at the above disclosed object of the present disclosure. Furthermore, the example operations may be performed in any order and in any combination.

The various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed in FIG. 3. The particular sequence of such executable instructions or associated data structures represents examples of corresponding acts for implementing the functions described in such steps or processes.

FIGS. 4a to 4c illustrates example wireless device configurations capable of performing some or all of the example method embodiments discussed above. It should be understood that entities in the drawings, e.g., blocks of the block diagrams, and also combinations of entities in the drawings, can be implemented by computer program instructions, which instructions can be stored in a computer-readable memory, and also loaded onto a computer or other programmable data processing apparatus. Such computer program instructions can be provided to a processor of a general purpose computer, a special purpose computer and/or other programmable data processing apparatus to produce a machine, such that the instructions, which execute via the processor of the computer and/or other programmable data processing apparatus, create means for implementing the functions/acts specified in the block diagrams and/or flowchart block or blocks.

FIG. 4a illustrates an example wireless device configuration capable of performing some or all of the example method embodiments discussed above. According to an aspect of the disclosure, the wireless device comprises a computer readable storage medium, storing a computer program which, when executed causes the wireless device to execute any or all of the above discussed example embodiments.

As disclosed in FIG. 4a, the wireless device comprises processing circuitry 41, arranged to control operation of the wireless device. In particular, the processing circuitry 41 controls uplink data packet barring in the wireless device.

The processing circuitry 41 is arranged for receiving a data packet from an application in the wireless device, determining access category for the data packet, and controlling user plane, UP, barring of the data packet based on the determined access category.

According to an aspect of the disclosure, the processing circuitry comprises a processor 41a and a memory 41b. The processor 41a may be any suitable type of computation unit or circuit, e.g. a microprocessor, digital signal processor, DSP, field programmable gate array, FPGA, or application specific integrated circuit, ASIC or any other form of circuitry. It should be appreciated that the processing circuitry need not be provided as a single unit but may be provided as any number of units or circuitry.

The memory 41b may be configured to store access category barring information. The memory 41b may further be configured to store received or transmitted data and/or executable program instructions. The memory 41b may be any suitable type of computer readable memory and may be of volatile and/or non-volatile type.

According to some embodiments, the processing circuitry is configured to support a functional distribution between a user plane, UP, a control plane, CP, a non access stratum, NAS, and an access stratum, AS, and wherein the CP is configured to store access category rules and barring information in a table.

According to some embodiments, the processing circuitry is configured to include one or more uplink packet filters in the table.

According to some embodiments, uplink packet filters are included in the table in response to a successful NAS signaling procedure establishing a new data packet flow or bearer.

According to some embodiments, uplink packet filters are removed from the table in response to release of a packet data flow.

FIG. 4b illustrates an example wireless device configuration capable of performing some or all of the example method embodiments discussed above. The wireless device 40 is configured to control uplink data packet barring in the wireless device. The wireless device comprises a data packet reception module 411 configured to receive a data packet from an application in the wireless device. The wireless device further comprises an access category determination module 412 for determining access category for the data packets and a user plane barring module 413 for controlling user plane, UP, barring of the data packet based on the determined access category.

FIG. 4c illustrates an example wireless device configuration capable of performing some or all of the example method embodiments discussed above. The disclosure in FIG. 4c provides further details with regard to the wireless device configuration and functional elements in support of the proposed solution. It should be noted that the present disclosure is only limited by the content of the embodiments and that the disclosure in FIG. 4c represents an example embodiment and merely proposes one out of many possible distributions of functional elements. The figure depicts a wireless device with its communication stack split into the Access Stratum (AS) and the Non-Access Stratum (NAS). The strata are further divided into User Plane (UP) and Control Plane (CP) parts.

The CP hosts the Access Category rules, amended with information on Uplink Packet Filters as described above and provisioned to the wireless device e.g. via network signaling, OTA provisioning or other means. Furthermore, the CP hosts the Barring Information broadcasted via RRC signaling to wireless devices from the radio network. The Access Category Rules and the barring information for wireless device originated uplink signaling and data may be organized as a joint table e.g. as depicted in above disclosed Table 1 (copied here below to improve the understanding of the associated text).

TABLE 1

| Access | | | |
|---|---|---|---|
| Category | Barred | Rule Criteria | Uplink Packet Filters |
| 1 | No | Emergency | N/A |
| | | Signalling | |
| 2 | No | NAS Signaling | N/A |
| 3 | No | SMS | N/A |
| 3 | No | MMTel Voice | Packet Filter A, |
| | | | Packet Filter B |
| 4 | Yes | MMTel Video | Packet Filter C |
| 5 | No | Category A APPs | Packet Filter D, |
| | | | Packet Filter E |
| 6 | Yes | Category B APPs | Packet Filter F |
| . . . | . . . | . . . | . . . |

The information on Uplink Packet Filters is added to the table when an application's request for a data bearer resource results in the setup of such bearer resources and a related Uplink Packet Filter is signaled to the wireless device. When a data bearer resource is inactivated the corresponding Uplink Packet Filters are removed from the table.

In the UP, during forwarding of uplink data packets, the Uplink Packet Filters are used for Access Category (AC) marking, based on the Access Category rules from CP. The packet filter mechanism could be the same as is used for QoS Flow Identity (QFI) marking, needed for QoS flow separation. After AC- and QFI marking, the data packets are forwarded to the Barring Enforcement entity that performs barring enforcement based on the Barring Information from CP. Barred packets are discarded (or alternatively buffered for some time period) while non-barred are forwarded to the access stratum. The barring Enforcement entity may send barring notifications to upper layers, e.g. to applications or to the Man-Machine Interface (MMI).

In summary, the present disclosure proposes barring enforcement to be performed in the protocol layers above the access stratum. The same mechanism may be used irrespective of the 5G access currently in use (NR, LTE, . . . ) in the access stratum.

In the present disclosure, it is additionally proposed to use data packet filtering on IP/UDP/TCP protocol parameters to determine access category. The analysis to determine access category could further be optimized by re-use of the logic needed for uplink filtering of data packets in the wireless device to determine to which uplink QoS flow a packet belongs. When using the same logic, the only additional part needed is the ability to map to an access category (in addition to a QoS flow ID) and when applicable determine that a packet should be discarded and not forwarded to the access stratum.

The solutions presented in the present disclosure, have the advantage that data packet filtering on IP/UDP/TCP protocol parameters to determine access category, allows for further possibilities of data packet classification that would not be manufacturer dependent.

The solution presented in the present disclosure are applicable for all wireless device states and may have well defined none OS dependent applications such as SMS, VoLTE voice and/or video as specific barring categories. When e.g. a new VoLTE call is set-up a user plane IP Flow with specific packet filtering is established and linked to the barring category e.g. realized as a table with linked uplink packet filters.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of source nodes, target nodes, corresponding methods, and computer program products. It should be appreciated that the example embodiments presented herein may be practiced in combination with each other.

1: A method for uplink data packet barring control in a wireless device, the method comprising:
receiving a data packet from an application in the wireless device;
determining access category for the data packet; and
controlling user plane barring of the data packet based on the determined access category.

2: The method of claim 1, wherein controlling UP barring of the data packet comprises discarding the data packet when the applied access category marking matches a barred access category.

3: The method of claim 1, wherein determining access category comprises
performing uplink filtering of data packets to determine an access category; and
applying an access category marking representing the determined access category.

4: The method of claim 3, wherein performing uplink filtering of data packet comprises filtering of data packets on IP/UDP/TCP protocol parameters.

5: The method of claim 1, wherein access category is determined from access category rules applicable to respective applications.

6: The method of claim 5, wherein the access category rules comprise packet filter information regarding one or more packet filter(s) to use to map packet flows to an access category.

7: The method of claim 1, wherein uplink filtering of data packets to determine an access category is performed in a filter applicable for QoS flow separation.

8: The method of claim 1, wherein uplink filters for determining access category are received in a NAS signaling message from the communications network.

9: The method of claim 1, wherein the method is performed for a wireless device in a state where there is an active packet data flow from an application.

10: The method of claim 1, wherein the data packets are part of an ongoing data packet stream from an application.

11: The method of claim 1, wherein the method is performed for an RRC idle, RRC inactive and RRC connected mode wireless device.

12: The method of any of claim 1, wherein the wireless device obtains barring information from one or more downlink broadcast messages received from an access node.

13: The method of claim 1, wherein the wireless device returns barring information to the application from which the one or more data packets are received.

14: A non-transitory computer readable storage medium, having stored thereon a computer program which, when executed by a processor in a wireless device, causes the wireless device to perform a method for uplink data packet barring control in a wireless device, the method comprising:
receiving a data packet from an application in the wireless device;
determining access category for the data packet; and
controlling user plane (UP) barring of the data packet based on the determined access category.

15: A wireless device configured for uplink data packet barring control, the wireless device comprising:
processing circuitry configured to:
receive a data packet from an application in the wireless device;
determine access category for the data packet; and
control user plane (UP) barring of the data packet based on the determined access category.

16: The wireless device of claim 15, wherein the processing circuitry is configured to support a functional distribution between a user plane, (UP) a control plane, (CP) a non access stratum (NAS) and an access stratum (AS), and wherein the CP is configured to store access category rules and barring information in a table.

17: The wireless device of claim 15, wherein the processing circuitry is configured to include one or more uplink packet filters in the table.

18: The wireless device of claim 17, wherein uplink packet filters are included in the table in response to a successful NAS signalling procedure establishing a new data packet flow or bearer.

19: The wireless device of claim 17, wherein uplink packet filters are removed from the table in response to release of a packet data flow.
